(19) United States
(12) Patent Application Publication
(10) Pub. No.: US 2015/0019476 A1
(43) Pub. Date: Jan. 15, 2015

(54) SYSTEMS AND METHODS FOR CONVERTING DATA FROM LEGACY COMPUTER SYSTEMS INTO TARGET FORMATS FOR TARGET COMPUTER SYSTEMS

(71) Applicant: Seven Seas Technologies Inc., Chesterfield, MO (US)

(72) Inventors: Sean M. Hiatt, Bath, MI (US); Matthew W. Royle, Bath, MI (US); Vidyasagar Nandela, Buffalo, NY (US); Michael W. Spangler, Lakeville, MN (US); Dayakar Veerlapati, Chesterfield, MO (US)

(73) Assignee: Seven Seas Technologies Inc., Chesterfield, MO (US)

(21) Appl. No.: 14/046,565

(22) Filed: Oct. 4, 2013

Related U.S. Application Data
(60) Provisional application No. 61/845,651, filed on Jul. 12, 2013.

(51) Int. Cl. G06F 17/30

(52) U.S. Cl. CPC G06F 17/30563
USPC 707/602

(57) ABSTRACT

A computer system for converting data from one of a plurality of different legacy systems to one of a plurality of different target systems includes one or more processors, memory, a database stored in the memory, and a software framework stored in the memory for execution by the one or more processors. Each of the plurality of different legacy systems has a legacy data format and each of the plurality of different target systems has a target data format. The software framework includes a plurality of software components callable by an output adaptor for performing a plurality of data conversion functions. The software framework is configured to interact with each of the plurality of different legacy systems having the legacy data format and/or each of the plurality of different target systems having the target data format. Other example computer systems and methods are also disclosed.

### CROSS-REFERENCE TO RELATED APPLICATION

This application claims the benefit of U.S. Provisional Application No. 61/845,651 filed on Jul. 12, 2013.

### FIELD

The present disclosure relates to systems and methods for converting data from legacy computer systems into target formats for target computer systems.

### BACKGROUND

This section provides background information related to the present disclosure which is not necessarily prior art.

Data conversion is the conversion of data from one format (e.g., a legacy format) to another format (e.g., a target format). Data conversion may become necessary when a firm, company, etc. implements a new software application different than a previous software application.

### SUMMARY

This section provides a general summary of the disclosure, and is not a comprehensive disclosure of its full scope or all of its features.

According to one aspect of the present disclosure, a method of converting data from legacy computer systems into target formats for target computer systems using a computer system having a generic software framework is disclosed. The generic software framework includes a plurality of software components for performing a plurality of data conversion functions. The method includes converting data from a first legacy computer system into a first target format for a first target computer system by selectively calling the plurality of software components of the generic software framework to convert the data in the first legacy computer system to said first target format for the first target computer system, and converting data from a second legacy computer system into a second target format for a second target computer system by selectively calling the plurality of software components of the generic software framework to convert the data in the second legacy computer system to said second target format for the second target computer system. The first and second legacy computer systems have different data formats or the first and second target computer systems have different data formats.

According to another aspect of the present disclosure, a computer system for converting data from a legacy system having a legacy data format to a target system having a target data format is disclosed. The computer system includes one or more processors, memory, a database stored in the memory, a software framework stored in the memory for execution by the one or more processors, an input adaptor stored in the memory for execution by the one or more processors, and an output adaptor stored in the memory for execution by the one or more processors. The software framework includes a plurality of software components for performing a plurality of data conversion functions. The input adaptor is configured to store data from the legacy system in the database of the computer system. The output adaptor is configured to selectively call the plurality of software components of the software framework to convert the legacy system data stored in the database into a target format and provide the data converted into the target format to the target system. The software framework stored in the memory is configured to interact with the legacy system having the legacy data format and the target system having the target data format.

According to yet another aspect of the present disclosure, a computer system for converting data from one of a plurality of different legacy systems to one of a plurality of different target systems is disclosed. Each of the plurality of different legacy systems has a legacy data format and each of the plurality of different target systems has a target data format. The computer system includes one or more processors, memory, a database stored in the memory, and a software framework stored in the memory for execution by the one or more processors. The software framework includes a plurality of software components callable by an output adaptor for performing a plurality of data conversion functions. The software framework is configured to interact with each of the plurality of different legacy systems having the legacy data format and/or each of the plurality of different target systems having the target data format.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram of a computer system including a database and a software framework according to one example embodiment of the present disclosure.

FIG. 2 is a block diagram of a portion of the computer system of FIG. 1 coupled to a legacy system and a target system according to another example embodiment.

FIG. 3 is a block diagram of a portion of the computer system of FIG. 1 connectable to multiple legacy systems and multiple target systems according to yet another example embodiment.

FIG. 4 is a block diagram of a computer system including a database and a software framework according to another example embodiment.

FIG. 5 is a flow chart of a method performed by a key retention component of the software framework of FIG. 4

FIG. 6 is a flow chart of a method performed by a code crosswalk component of the software framework of FIG. 4.

FIG. 7 is a flow chart of a method performed by a balancing component of the software framework of FIG. 4.

FIG. 8 is a flow chart of a method performed by a reconciliation component of the software framework of FIG. 4.

FIG. 9 is a flow chart of a method performed by a reporting component of the software framework of FIG. 4.

FIG. 10 is a computer system including multiple computer servers according to another example embodiment.

FIG. 11 is a flow chart of a method of converting data from legacy computer systems into target formats for target computer systems according to yet another example embodiment.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

A computer system for converting data from a legacy system having a legacy data format to a target system having a target data format according to one example embodiment of the present disclosure is illustrated in FIG. 1 and indicated generally by reference number 100. As shown in FIG. 1, the computer system 100 includes one or more processors 102, memory 104, a database 106 stored in the memory 104, a software framework 108, an input adaptor 110, and an output adaptor 112. The software framework 108, the input adaptor 110 and the output adaptor 112 are stored in the memory 104 for execution by the one or more processors 102. The software framework 108 stored in the memory 104 is configured to interact with the legacy system having the legacy data format and the target system having the target data format.

As shown in the example of FIG. 1, the software framework 108 includes software components 114 for performing data conversion functions.

The input adaptor 110 is configured to store data from the legacy system in the database 106 of the computer system 100. The output adaptor 112 is configured to selectively call the software components 114 of the software framework 108 to convert the legacy system data stored in the database 106 into a target format and provide the data converted into the target format to the target system.

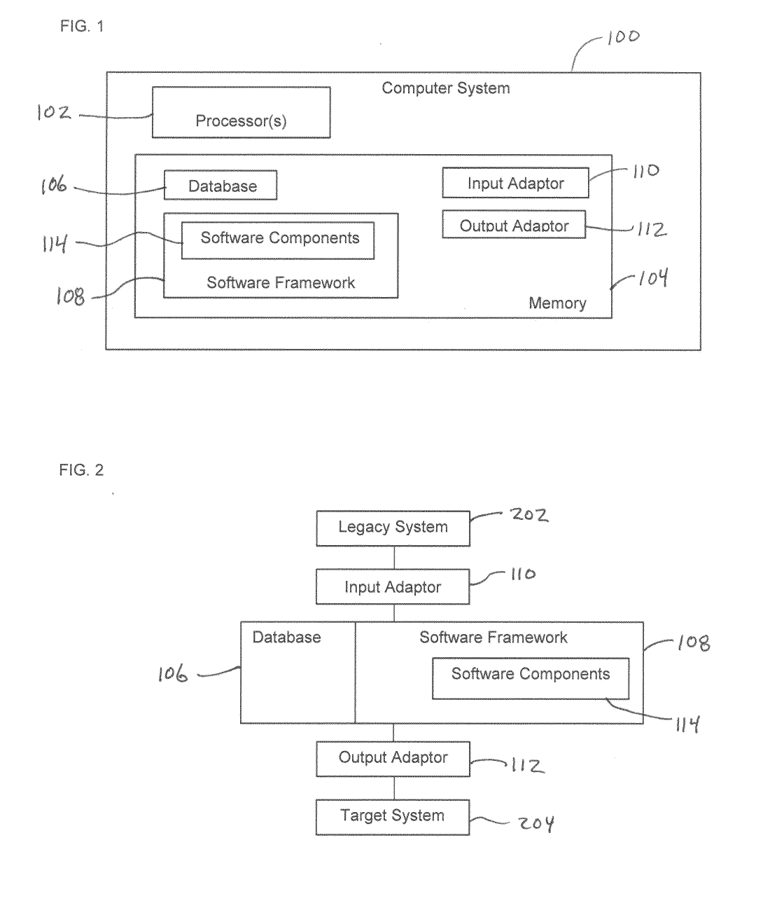

For example, as shown in FIG. 2, the input adaptor 110 may be in communication with a legacy system 202, the software framework 108, and the database 106. This allows the input adaptor 110 (sometimes referred to herein as a source adaptor) to pull data from the legacy system 202 (e.g., a legacy system database) and store the legacy system data in the database 106 of the computer system 100.

Similarly, the output adaptor 112 may be in communication with a target system 204 as well as the software framework 108 and the database 106. In this way, the output adaptor 112 is able to call one or more software components 114 to convert legacy system data stored in the database 106 into the target format and provide the converted data to the target system 204 (e.g., a target system database).

Because the software framework 108 may interact with different legacy systems having a different legacy data format and different target systems having a different target data format as explained above, the software framework 108 may be considered generic to the different legacy systems and/or the different target systems. In this way, the generic software framework 108 may include conversion components (e.g., one or more of the software components 114, etc.) reusable in one or more different data conversion projects. This allows the reusable conversion components to be part of a pre-built data conversion module and, in some cases, an entire pre-built data conversion module. Thus, the conversion process for converting data in the legacy system 202 to a format for the target system 204 may be accelerated and therefore early delivery of the converted data may be achieved. By delivering the converted data to the target system earlier than conventional non-generic systems, additional and/or more thorough testing of the converted data may be performed, conversion defects may be identified and corrected, etc.

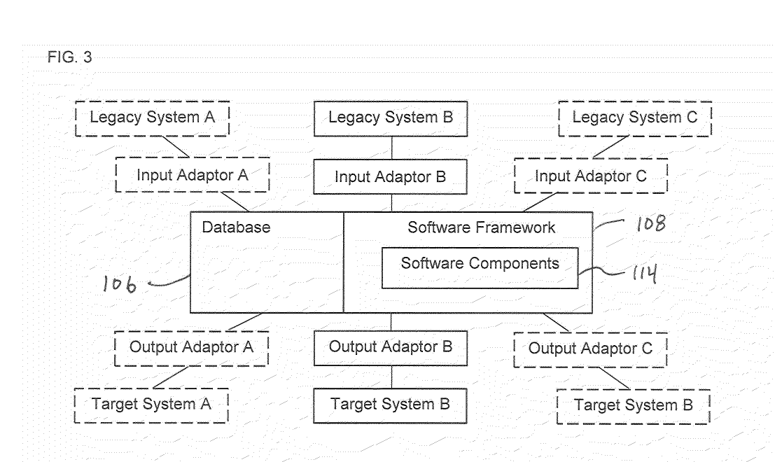

For example, as shown in the example embodiment of FIG. 3, the software framework 108 including the software components 114 is able to convert data in a legacy system B to a format for a target system B. As explained above, an input adaptor B stores data from the legacy system B in the database 106 and an output adaptor B selectively calls one or more of the software components 114 to convert the legacy system data stored in the database 106 into the target format and provides the converted data to the target system B.

Additionally and/or alternatively, the software framework 108 shown in FIG. 3 may convert data from other legacy systems to formats for other targets systems without substantially redeveloping (including, in some cases, without redeveloping at all) the software framework 108. For example, the software framework 108 may also convert data in legacy system A to a format for target system A using an input adaptor A and an output adaptor A and/or data in legacy system C to a format for target system C using an input adaptor C and an output adaptor C.

To achieve this, the software framework 108 may be generic to differently formatted legacy and/or target systems while the input adaptors and/or the output adaptors may be customized adaptors to communicate with specifically formatted legacy and/or target systems. For example, the input adaptor A may be a customized adaptor developed according to the format of the legacy system A while the input adaptor C may be a different customized adaptor developed according to the format of the legacy system C, which is different than the format of the legacy system A.

Alternatively, the target system A and/or the legacy system A may be substantially similar to the target system C and/or the legacy system C. In that instance, some or all of components of the input adaptor and/or the output adaptor may be reused for subsequent conversion projects. For example, the target system A and the target system C may have the same (or substantially the same) format. Accordingly, the same (or substantially the same) output adaptor may be used in converting data from legacy system A to target system A and converting data from legacy system C to target system C.

Thus, the input adaptor and/or the output adaptor may be substantially generic. Therefore, similar to the software frameworks explained herein, the input adaptor and/or the output adaptor may accelerate the data conversion process and thus early delivery of converted data may be achieved.

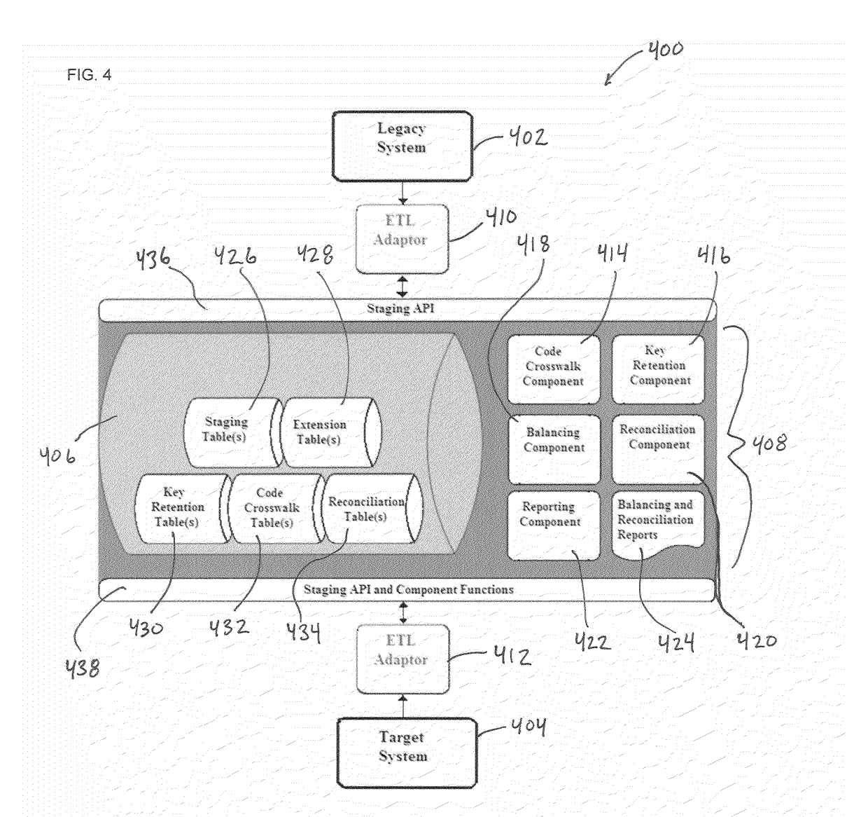

FIG. 4 illustrates an example computer system 400 including a software framework 408, a database 406, an input adaptor 410, and an output adaptor 412. As explained above, the software framework 408, the database 406, the input adaptor 410, and the output adaptor 412 may be stored in memory and executed (if applicable) by one or more processors.

The input adaptor 410 and/or the output adaptor 412 of FIG. 4 may be similar to the input adaptor 110 and/or the output adaptor 112 of FIG. 1 explained above. Additionally, in some example embodiments, the input adaptor 410 may store data from a legacy database of a legacy system 402 in the database 406 and/or the output adaptor 412 may provide the data converted into a target format to a target database of a target system 404.

In the example embodiment of FIG. 4, the adaptors 410, 412 are extract, transform, and load (ETL) adaptors and are in communication with the software framework 408 and the database 406. Alternatively, any other suitable type(s) of adaptors may be employed.

The computer system 400 may include application programming interfaces (APIs) 436, 438 between the adaptors 410, 412, and the software framework 408 and database 406. The APIs 436, 438 may specify how one or more software components (explained below) of the software framework 408 interact with each other, how the adaptors 410, 412 interact with the database 406 and the software framework 408, etc.

Although the interfaces 436, 438 are shown as APIs in FIG. 4, any other suitable interfaces may be employed including, for example, interfaces having ETL functions, database functions, Java functions, etc.

The legacy system 402 and the target system 404 may store and process information related to a health care system including, for example, health care claims, members of a health care program, providers of a health care program, etc. Alternatively, the legacy system 402 and the target system 404 (or other legacy systems and/or target systems disclosed herein) may store and process other types of information.

As shown in FIG. 4, the database 406 may include tables for storing data from the legacy system 402, such as a staging table 426, an extension table 428, a key retention table 430, a code crosswalk table 432, and a reconciliation table 434. It should be understood that each table (e.g., the staging table 426) may include one or more tables. Additionally and/or alternatively, the database 406 may include more or less tables without departing from the scope of the present disclosure. For example, in some embodiments the database 406 may not include the reconciliation table 434.

The software framework 408 may include software components for performing data conversion functions. In the example embodiment of FIG. 4, the software components include a code crosswalk component 414, a key retention component 416, a balancing component 418, a reconciliation component 420, a reporting component 422, and balancing and reconciliation reports 424. Alternatively, more or less software components performing different conversion functions may be employed without departing from the scope of the present disclosure. Additionally and/or alternatively, the data conversion functions of the software components may be performed by other suitable component(s) without departing from the scope of the present disclosure.

In the example embodiment of FIG. 4, the staging tables 426 stored in database 406 may be configured to store data received from the legacy system 402. In some embodiments, the staging tables 426 may represent a neutral staging environment to house the legacy data. The neutral staging environment may contain common data elements and/or structures for one or more business industries.

The extension tables 428 may be configured to store data external to the legacy system 402. The extension tables 428 may be linked to one or more of the staging tables 426 and may include similar characteristics of the staging tables 426 explained above.

In some embodiments, the extension tables 428 may allow for a real-time addition of data elements and/or structures not contained in the neutral staging environment explained above without modifying the primary staging table structures. Thus, the extension tables 428 may store the external data and/or any other data without substantially modifying (or in the some cases, without modifying at all) the data stored in the staging tables 426.

The staging tables 426 and/or the extension tables 428 may assist in overcoming differences between the legacy system 402 and/or the target system 404. For example, the legacy system 402 may include one or more mainframe based COBOL data structures and/or other specifically programmed data structures which may not be conducive to querying functions and/or data analysis. Additionally, the legacy system 402 may employ data in different tables, structures, etc. as compared to corresponding tables, structures, etc. of the target system 404. For example, addresses of clients may be attached to clients in the legacy system 402 but may be stored in contact address tables in the target system 404.

The target system 404 may have one or more complex, normalized database structures that may be based on Commercial off the Shelf (COTS) systems. Additionally, the target system 404 may utilize data that is spread across multiple components of the target system, may use different naming conventions and/or nomenclature than the legacy system 402, etc.

Accordingly, the generic staging tables 426 and/or extension tables 428 explained above may include data elements and/or structures that may be queried and analyzed and contain tables employing common naming conventions and/or nomenclature.

In the example of FIG. 4, the key retention tables 430 may be configured to store generated identifications assignable to data of the legacy system 402. For example, a member, a provider, etc. of a health care system may be assigned an identification (e.g., a key) number 12345 in the legacy system 402. This identification number, as well as other identification numbers for other members, providers, etc., may be stored in the key retention tables 430.

The key retention component 416 may link the generated identifications to data received from the legacy system 402 and generate identifications assignable to data for the target system 404. In some embodiments, an internal identification (e.g., a key) may be generated in the target system 404 that corresponds to the member, the provider, etc. explained above. For example, an internal key (e.g., identification number 0001) may be generated and linked to the identification number 12345 of the legacy system 402 explained above. This internally generated identification may be referenced by tables from other functional components of the target system 404 if desired.

By linking the identifications of the target system 404 to identifications of the legacy system 402, subsequent data (e.g., health care claim records, etc.) associated with the identification number 12345 of the legacy system 402 may also be linked to the identification number 0001 of the target system 404. Therefore, once a member, a provider, etc. is assigned an internal identity key, that association may be retained so that each time data from the legacy system 402 is converted, the data is assigned the same internal identity key. This may provide the ability to selectively re-convert member data, provider data, etc. without invalidating other associated data (e.g., health care claim data, etc.) referencing that member, provider, etc.

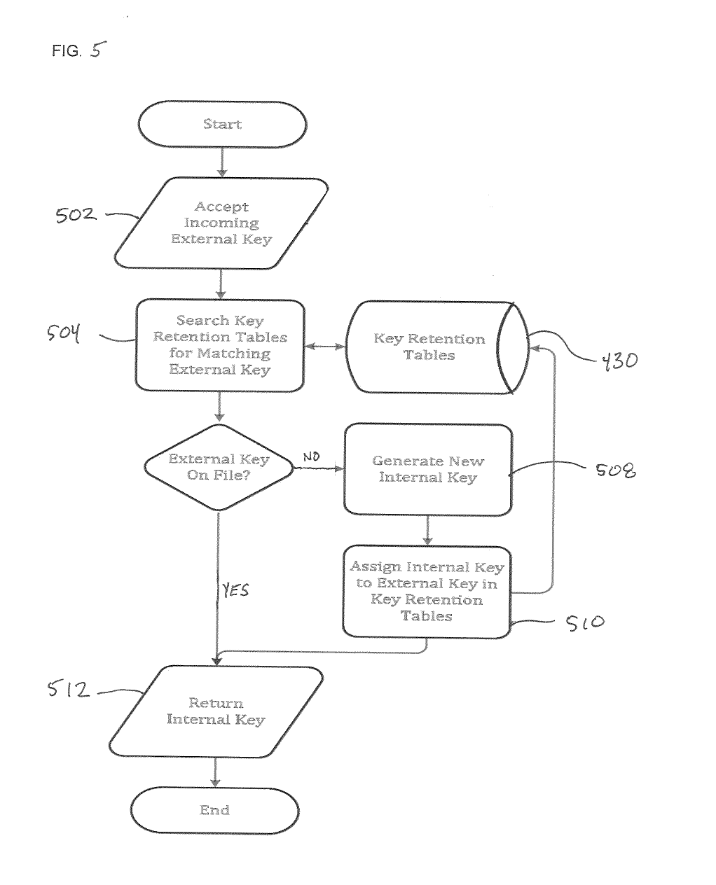

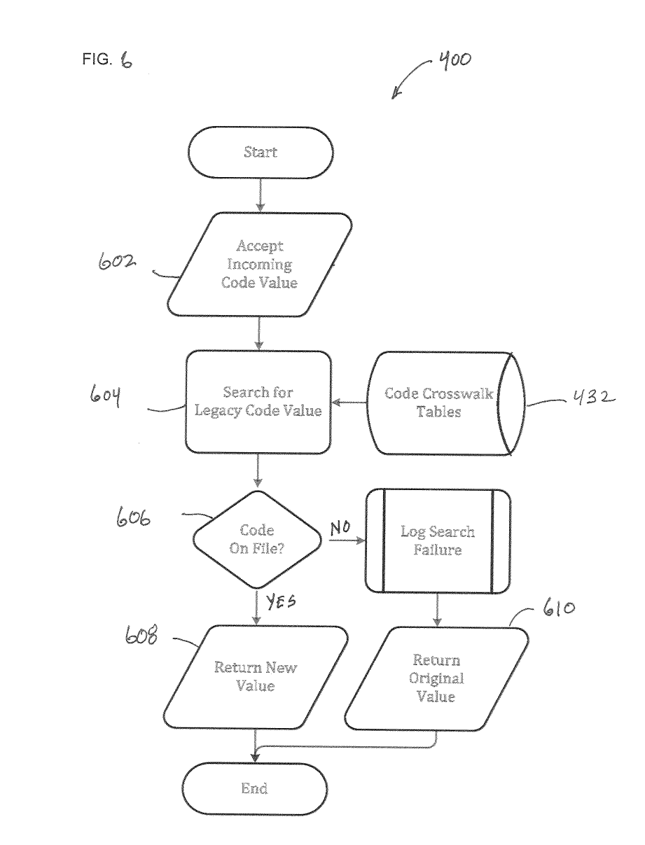

FIG. 5 illustrates an example method 500 performed by the key retention component 416 of the computer system 400 of FIG. 4. As shown in FIG. 5, the method 500 includes accepting an external key from the legacy system 402 (block 502) and searching the key retention tables 430 for the accepted external key (block 504). If the external key is on file (e.g., it is found in the key retention tables 430), the key retention component 416 may return, in block 512, an internal key (e.g., identification number 0001) corresponding to the external key (e.g., identification number 12345). If the external key is not on file, the key retention component 416 may generate a new internal key (e.g., identification number 0002) in block 508 and assign the new internal key to the external key (e.g., identification number 12340) in block 510. The key retention component 416 may then return the new internal key (e.g., identification number 0002) corresponding to the new external key (e.g., identification number 12340).

Referring back to FIG. 4, the code crosswalk tables 432 may be configured to store one or more legacy code values of the legacy system 402. For example, the legacy system 402 may employ a code value M for a male and a code value F for a female. These legacy code values, other code values including target system code values (further explained below), type(s) of code values, etc. may be stored in the code crosswalk tables 432.

The code crosswalk component 414 may provide one or more target code values to the target system 404 corresponding to the one or more legacy code values stored in the code crosswalk table 432. In this way, the code crosswalk component 414 may convert code values from the legacy system 402 to the code values supported by the target system 404. For example, the target system 404 may employ a code value 1 for a male and a code value of 0 for a female. Therefore, the code crosswalk component 414 may provide the target code values (e.g., 0 and 1) corresponding to the legacy code values (e.g., F and M) to the target system 404 when appropriate.

By employing the code crosswalk tables 432 and/or the code crosswalk component 414 as explained above, hard coded crosswalks from a legacy system to a target system may be substantially eliminated including, in some cases, completely eliminated. Additionally, these code values may be maintained throughout the conversion process. Thus, the conversion process may be completed without changing codes for particular code values.

FIG. 6 illustrates an example method 600 performed by the code crosswalk component 414 of the computer system 400 of FIG. 4. As shown in FIG. 6, the method 600 includes accepting a legacy code value in block 602 and searching the code crosswalk tables 432 for the accepted legacy code value in block 604. If the legacy code value is on file (e.g., it is found in the code crosswalk tables 432), the code crosswalk component 414 may return, in block 608, a code value for the target system 404 corresponding to the accepted legacy code value. If the legacy code value is not on file (e.g., it is not found in the code crosswalk tables 432), a log search failure may be indicated and the code crosswalk component 414 may return the legacy code value to the target system 404 in block 610. Alternatively, the code crosswalk component 414 or any other suitable component may return a code value (e.g., “All Others”, etc.) for the target system 404 corresponding to any one or more of the legacy code values not found in the code crosswalk tables 432.

Referring back to FIG. 4, the balancing component 418 may generate data conversion statistics. For example, clients may request status reports and/or other statistics for one or more conversion jobs. These status reports and other statistics are commonly referred to as metrics. The metrics may document whether the job ran successfully (e.g., success or fail), how long the job took, how many records (e.g., health care claim records) were processed successfully and/or rejected during the job, etc.

Additionally, the metrics may allow developers to performance tune conversion modules, identify job failures and/or unexpected results, etc. For example, a job may have succeeded, but the results may be suspect if the job statistics indicate a significant number of rejected records, a low number of written records, etc.

The metrics may be stored and/or generated by one or more of the tables stored in the database 406, the software components described herein, the input and/or output adaptors 410, 412, etc. In some embodiments, the balancing component 418 may be called by the input and/or output adaptors 410, 412 to automatically generate the metrics explained above. Data corresponding to the metrics may be stored in the table(s) in the database 406 allowing for a comparison of metrics from prior conversions jobs. Accordingly, this may allow developers to determine if the conversion job was successful, if the associated results are outside of normal parameters, etc.

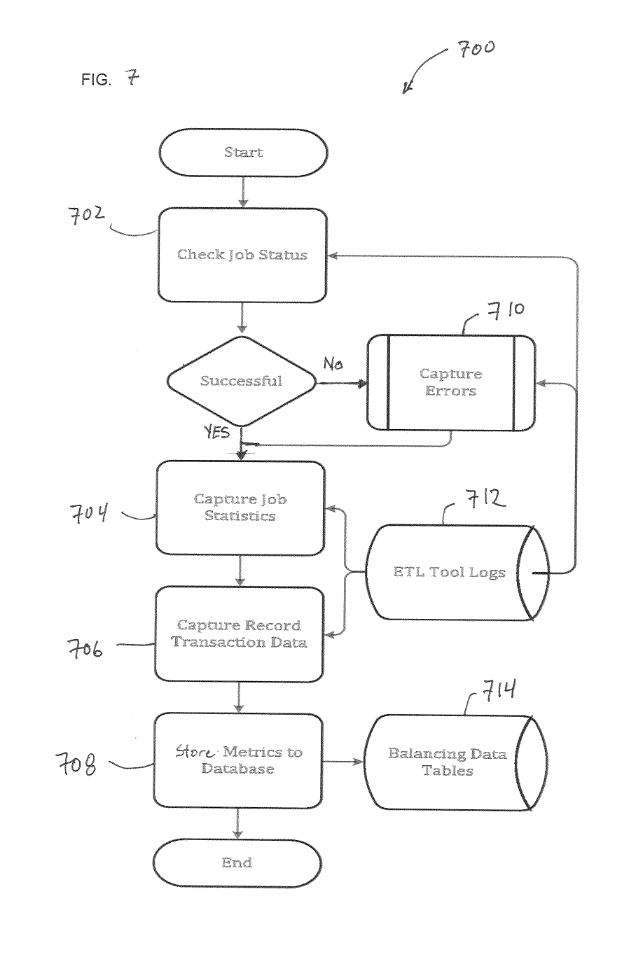

FIG. 7 illustrates an example method 700 performed by the balancing component 418 of the computer system 400 of FIG. 4. As shown in FIG. 7, the method 700 includes checking a job status in block 702 based on input from tool logs 712 from the input and/or output adaptors 410, 412 of FIG. 4. The method 700 may further include determining if one or more records were processed successfully. If a record was processed successfully, the balancing component 418 may capture job statistics in block 704 and capture record transaction data in block 706, both of which are based on input from the tool logs 712. In block 708, the captured metrics (e.g., the job statistics, record transaction data, and any other captured metrics) may be stored into the database 406. For example, the captured metrics may be stored in one or more balancing data tables 714 (not shown in FIG. 4) of the database 406. In some embodiments, the reconciliation tables 434 may include one or more tables (e.g., the balancing data tables 714) for storing the captured metrics.

If the record was not processed successfully, the balancing component 418 may capture the error(s) in block 710 based on input from the tool logs 712. The captured error(s) may be stored in the balancing data tables 714, the reconciliation tables 434, etc. as explained above.

Referring back to FIG. 4, the reconciliation component 420 may compare data from the legacy system 402 and the data converted into the target format for the target system 404. For example, the reconciliation component 420 may provide a confirmation that data from the legacy system 402 was properly converted into the target system format and completely loaded into the target system 404.

In some embodiments, member data may be reconciled by ensuring that a count of active and inactive members in the target system 404 matches a count of active and inactive members in the legacy system 402. Additionally, health care claims may be reconciled by ensuring that the sum of paid claims in a particular period of time is the same for the legacy system 402 and for the target system 404.

The reconciliation component 420 may allow developers to identify the data they want to reconcile, have flexibility on how they are able reconcile the data (e.g., based on job control parameters), dynamically generate results based on the desired statistics, etc. For example, the reconciliation component 420 may be called by the output adaptor 412, which may allow for substantially immediate generation of reconciliation results.

Additionally and/or alternatively, the reconciliation component 420 may count data, summarize data, compare legacy system data to target system data, produce target system data results for comparison against legacy system reports, etc.

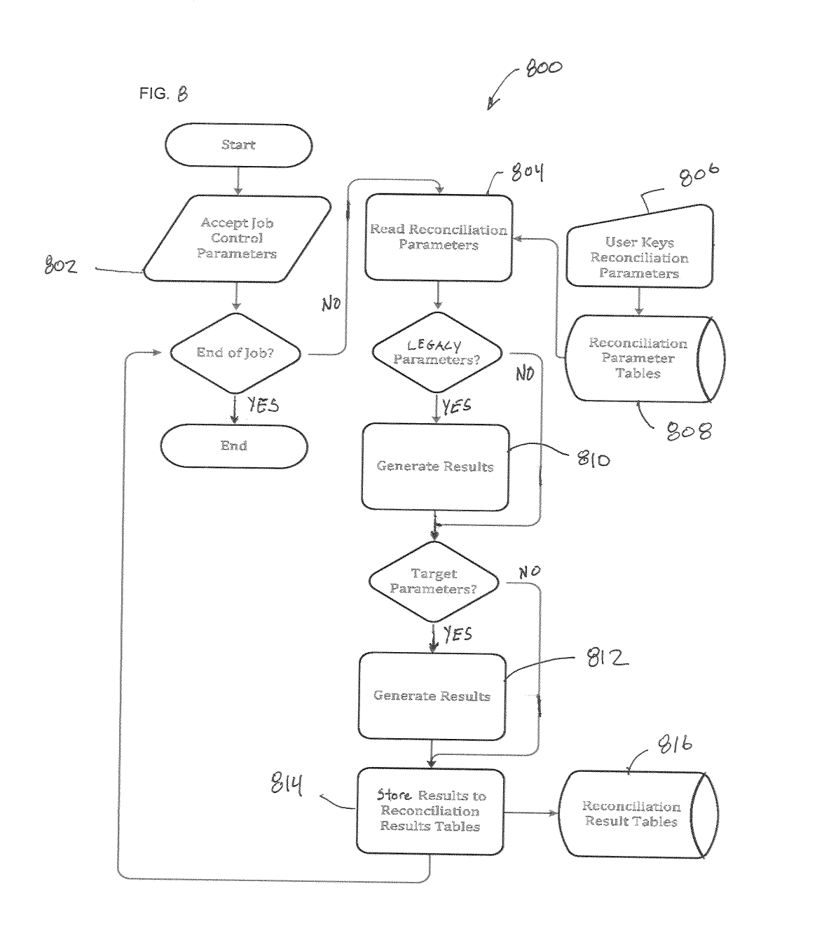

FIG. 8 illustrates an example method 800 performed by the reconciliation component 420 of the computer system 400 of FIG. 4. As shown in FIG. 8, the method 800 includes accepting job control parameters in block 802. For example, the job control parameters may include parameters that execute the reconciliation component 420 for one or more functional components of the target system 404.

If the conversion job is not completed, the reconciliation component 420 may read reconciliation parameters in block 804. The reconciliation parameters may be keyed by users in block 806 and stored in one or more reconciliation parameters tables 808 (e.g., of the reconciliation tables 434). The reconciliation parameters may be configured by a client and may include a particular table to reconcile, a particular field to reconcile, a type of metric (e.g., a count, sum, etc.), etc.

The reconciliation component 420 may determine if the reconciliation parameter is a legacy parameter and/or a target parameter. If so, the reconciliation component 420 may generate results for each parameter in blocks 810, 812. In block 814, the generated results may be stored into one or more reconciliation results tables 816 (e.g., of the reconciliation tables 434).

Referring back to FIG. 4, the reporting component 422 may generate reports including the generated data conversion statistics from the balancing component 418 and/or results from the reconciliation component 420. The reporting component 422 may generate the reports based on search parameters defined by a user, a client, etc. The generated reports can be printed and/or saved electronically. Additionally, the generated reports may be created for an individual conversion job, multiple conversion jobs (e.g., one or more conversion jobs on multiple conversion modules), etc.

The generated reports may include the metrics (e.g., requested status reports, statistics for conversion jobs, etc.) as well as the results from the comparison(s) performed by the reconciliation component 420, both of which are explained above. Therefore, the reporting component 422 may provide conversion job results, statistics, runtimes, reconciliation results, etc.

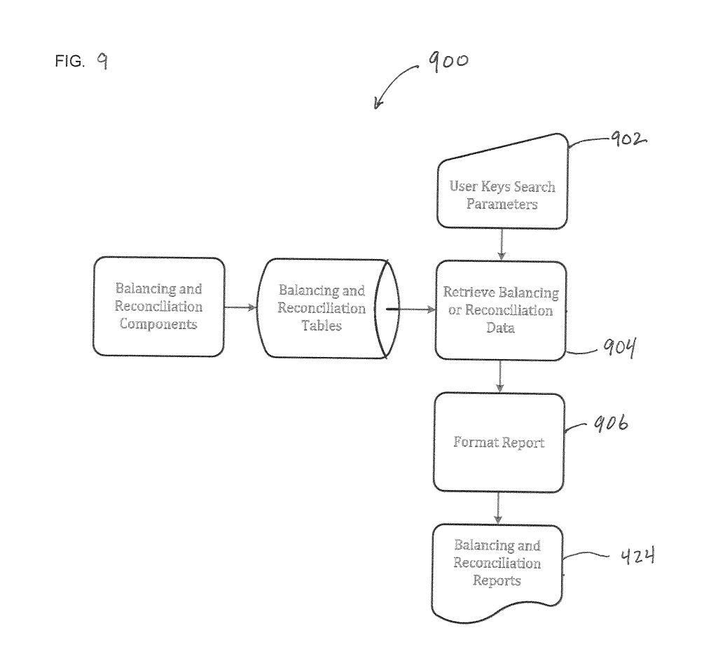

FIG. 9 illustrates an example method 900 performed by the reporting component 422 of the computer system 400 of FIG. 4. As shown in FIG. 9, the method 900 includes providing search parameters in block 902 and retrieving data corresponding to the search parameters in block 904. As shown in FIG. 9, the retrieved data may be generated by the balancing component 418 and/or the reconciliation component 420, and stored in the appropriate tables. The reporting component 422 may also format the report as desired in block 906 and store the report in the balancing and reconciliation reports 424 of the software framework 408. As explained above, the generated report may be viewed online, saved electronically, and/or printed from the balancing and reconciliation reports 424.

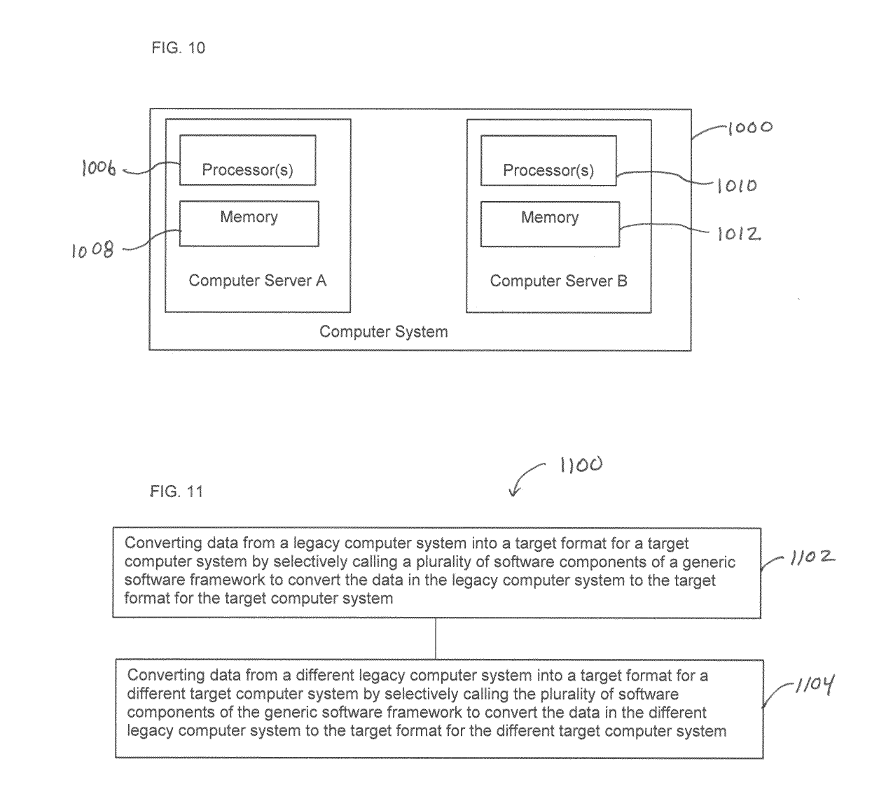

The computer systems disclosed herein may include one or more computer servers having memory. For example, as shown in FIG. 10, the computer system 1000 includes a computer server A having memory 1008 and processors 1006 and a computer server B having memory 1012 and processors 1010. The memory 1008, 1012 may be substantially similar to the memory 104 of FIG. 1. For example, each memory 1008, 1012 may include the database 106, the software framework 108, the input adaptor 110, and the output adaptor 112 explained above with reference to FIG. 1. Alternatively, the memory 1008 and/or the memory 1012 may include some or all of a database, software components of a software framework, an input adaptor, and/or an output adaptor.

Additionally, the computer systems (e.g., the computer system 100) may be different from or the same as the legacy computer systems disclosed herein and/or the target computers systems disclosed herein. For example, the computer system 100 may include the legacy computer system 202 and/or the target computer system 204.

FIG. 11 is a method 1100 of converting data from legacy computer systems to target computer systems using a generic software framework including a plurality of software components for performing a plurality of data conversion functions. Any one of the computer systems disclosed herein and/or any other suitable computer systems may be configured to perform the method 1100.

The legacy computer systems and/or the target computer systems may be similar to the legacy systems and/or target systems described herein. For example, the legacy computer systems may have different data formats while the target computer systems may have the same data formats. Alternatively, the legacy computer systems may have the same data formats while the target computer systems may have different data formats.

As shown in FIG. 11, the method 1100 includes, in block 1102, converting data from a legacy computer system into a target format for a target computer system by selectively calling the plurality of software components of the generic software framework to convert the data in the legacy computer system to the target format for the target computer system. The method 1100 further includes, in block 1104, converting data from a different legacy computer system into a target format for a different target computer system by selectively calling the plurality of software components of the generic software framework to convert the data in the different legacy computer system to the target format for the different target computer system.

The memory described herein may store computer-readable instructions for performing the methods described above while the processors described herein may execute the computer-readable instructions. Additionally and/or alternatively, the computer-readable instructions for performing the methods may be stored on a non-transitory computer-readable medium including, for example, disks, SD cards, DVD, CD-ROMs, ROMs, RAMs, EPROMs, EEPROMs, DRAMs, VRAMs, flash memory devices, or any other suitable medium for storing instructions. Therefore, the memory may be internal memory and/or external memory.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1-9. (canceled)

10. A computer system for converting data from a legacy system having a legacy data format to a target system having a target data format, the computer system comprising:
one or more processors;
memory;
a database stored in the memory;
a software framework stored in the memory for execution by the one or more processors, the software framework including a plurality of software components for performing a plurality of data conversion functions;
an input adaptor stored in the memory for execution by the one or more processors, the input adaptor configured to store data from the legacy system in the database of the computer system; and
an output adaptor stored in the memory for execution by the one or more processors, the output adaptor configured to selectively call the plurality of software components of the software framework to convert the legacy system data stored in the database into a target format and provide the data converted into the target format to the target system,
wherein the software framework stored in the memory is configured to interact with the legacy system having the legacy data format and the target system having the target data format.

11. The computer system of claim 10 wherein at least one of the input adaptor and the output adaptor includes an extract, transform, and load (ETL) adaptor.

12. The computer system of claim 10 wherein the software components include a reconciliation component configured to compare the legacy system data and data converted into the target format.

13. The computer system of claim 12 wherein the software components include a balancing component configured to generate data conversion statistics.

14. The computer system of claim 13 wherein the software components include a reporting component configured to generate one or more reports comprising at least one of the generated data conversion statistics and results from the reconciliation component.

15. The computer system of claim 10 wherein the database includes one or more staging tables configured to store data received from the legacy system.

16. The computer system of claim 15 wherein the database includes one or more extension tables configured to store data external to the legacy system.

17. The computer system of claim 16 wherein the extension tables are configured to store data without modifying the data stored in the staging tables.

18. The computer system of claim 10 wherein the database includes one or more key retention tables configured to store generated identifications assignable to data of the legacy system and wherein the software components include a key retention software component configured to link the generated identifications to data received from the legacy system and to generate identifications assignable to data for the target system.

19. The computer system of claim 10 wherein the database includes a code crosswalk table configured to store one or more legacy code values of the legacy system and wherein the software components include a code crosswalk software component configured to provide one or more target code values to the target system corresponding to the one or more legacy code values stored in the code crosswalk table.

20. The computer system of claim 10 wherein the legacy system and the target system are configured to store and process information related to health care claims.

21. A computer system for converting data from one of a plurality of different legacy systems to one of a plurality of different target systems, each of the plurality of different legacy systems having a legacy data format and each of the plurality of different target systems having a target data format, the computer system comprising:
one or more processors;
memory;
a database stored in the memory; and
a software framework stored in the memory for execution by the one or more processors, the software framework including a plurality of software components callable by an output adaptor for performing a plurality of data conversion functions, the software framework configured to interact with each of the plurality of different legacy systems having the legacy data format and/or each of the plurality of different target systems having the target data format.

22. The computer system of claim 21 wherein at least one of the different legacy systems and at least one of the different targets systems are configured to store and process information related to health care claims.

23. The computer system of claim 21 further comprising an input adaptor stored in the memory for execution by the one or more processors and an output adaptor stored in the memory for execution by the one or more processors, the input adaptor configured to store data from said one of the plurality of different legacy systems in the database of the computer system, the output adaptor configured to selectively call the plurality of software components of the software framework to convert the data from said one of the plurality of different legacy systems stored in the database into a target format and provide the data converted into the target format to said one of the plurality of different target systems.

24. The computer system of claim 23 wherein at least one of the input adaptor and the output adaptor includes an extract, transform, and load (ETL) adaptor.

25. The computer system of claim 21 wherein the database includes one or more key retention tables configured to store generated identifications assignable to data of said one of the plurality of different legacy systems and wherein the software components include a key retention software component configured to link the generated identifications to data received from said one of the plurality of different legacy systems and to generate identifications assignable to data for said one of the plurality of different target systems.

26. The computer system of claim 21 wherein the database includes one or more staging tables configured to store data received from said one of the plurality of different legacy systems.

27. The computer system of claim 26 wherein the database includes one or more extension tables configured to store data external to the said one of the plurality of different legacy systems.

28. The computer system of claim 27 wherein the extension tables are configured to store data without modifying the data stored in the staging tables.

29. The computer system of claim 21 wherein the database includes a code crosswalk table configured to store one or more legacy code values of said one of the plurality of different legacy systems and wherein the software components include a code crosswalk software component configured to provide one or more target code values for said one of the plurality of different target systems corresponding to the one or more legacy code values stored in the code crosswalk table.

30. The computer system of claim 21 wherein the software components include a balancing component configured to generate data conversion statistics.

31. The computer system of claim 30 wherein the software components include a reconciliation component configured to compare data from said one of the plurality of different legacy systems and data converted into the target format for said one of the plurality of different target systems.

32. The computer system of claim 31 wherein the software components include a reporting component configured to generate one or more reports comprising at least one of the generated data conversion statistics and results from the reconciliation component.

33. The computer system of claim 21 wherein the computer system includes a plurality of computer servers, and wherein the memory includes memory in each of the plurality of computer servers.
